(19) United States
(12) Patent Application Publication
(10) Pub. No.: US 2024/0027602 A1
(43) Pub. Date: Jan. 25, 2024

(54) METHODS AND DEVICES FOR DETECTING MOTION

(71) Applicants: Khalifa University of Science and Technology, Abu Dhabi (AE); British Telecommunications PLC, London (GB); Emirates Telecommunications Corporation, Abu-Dhabi (AE)

(72) Inventors: Anas AL RAWI, Abu Dhabi (AE); Ian COOPER, Abu Dhabi (AE); Ubaid ur R AHMAD, Abu Dhabi (AE); Trevor MORSMAN, Abu Dhabi (AE); Nawaf ALMOOSA, Abu Dhabi (AE)

(21) Appl. No.: 18/256,443

(22) PCT Filed: Dec. 30, 2020
(86) PCT No.: PCT/GB2020/053377

§ 371 Date: Jun. 8, 2023

(51) Int. Cl. G01S 13/62; G01S 7/00; G01S 7/03

(52) U.S. Cl. CPC G01S 13/62; G01S 7/003; G01S 7/03

(57) ABSTRACT

This invention relates to methods and devices for detection of motion. Embodiments of the invention provide a method of detecting motion of an object using a wireless transceiver device, the method including the steps of: transmitting wireless signals from a transmitter element in the transceiver device, the signals being reflected by the object; receiving the signals reflected by the object in a receiver element in the transceiver device; estimating at least one channel characteristic from the reflected signals; applying a time and/or frequency domain analysis to the estimated channel characteristic; detecting any variation in the estimated channel characteristic over time; and detecting motion of the object based on the detected variation. A wireless transceiver device arranged to detect motion is also provided.

### FIELD OF THE INVENTION

The present invention relates to methods and devices for detecting motion. It is particularly, but not exclusively, concerned with methods and devices for detecting motion using a wireless access point.

### BACKGROUND OF THE INVENTION

Wireless sensing is an emerging by-product application of communication systems. It can provide feedback to various events within the coverage of the wireless sensing device. Current methods typically rely on the changes of the radio frequency (RF) characteristics such as variation in the received signal strength, changes in angle of arrival, time of arrival and/or channel state information all between paired devices.

RF characteristics change due to changes in the environment and often these changes are only used in the physical layer to adapt the communication and ensure maximum performance and throughput. In addition to that, the RF characteristics can be fed to the application layer to introduce new applications over which the communication devices can report the changes in the environment seen in the physical layer as actual motions. Such capabilities enable numerous applications in both security, health and environmental monitoring.

Existing approaches typically depend on the RF characteristics between paired devices. For instance, if an access point (e.g. a BT home hub) 10 is connected to a smart home device 20 as shown in FIG. 1 and a motion occurs in between the two, the received signal strength and the channel estimation will affected significantly. If the locations of both devices are fixed then the motion can be also localised. This is the simplest approach to conduct motion detection and localisation. However, it is heavily dependent on the fact that there is at least one connected device and can be dependent on the relative positioning of the devices. The quality of sensing is proportional to the number of the connected devices. This is a significant disadvantage in such approach.

An object of the present invention is to address the above problems by providing methods and devices for detection of motion which can operate from a single wireless transceiver.

A further object of the present invention is to provide methods and devices for the detection of motion which are adaptable and flexible to the circumstances.

### SUMMARY OF THE INVENTION

An exemplary embodiment of the invention provides a method of detecting motion of an object using a wireless transceiver device, the method including the steps of: transmitting wireless signals from a transmitter element in the transceiver device, the signals being reflected by the object; receiving the signals reflected by the object in a receiver element in the transceiver device; estimating at least one channel characteristic from the reflected signals; applying a time and/or frequency domain analysis to the estimated channel characteristic; detecting any variation in the estimated channel characteristic over time; and detecting motion of the object based on the detected variation.

A further exemplary embodiment of the invention provides a wireless transceiver device having a transmitter element, a receiver element and a controller, wherein: the transmitter element is arranged to transmit wireless signals, which are reflected by an object; the receiver element is arranged to receive the reflected wireless signals; and the controller is arranged to: estimate at least one channel characteristic from the reflected signals; apply a time and/or frequency domain analysis to the estimated channel characteristic; and detect any variation in the estimated channel characteristic over time and thereby detect motion of the object based on the detected variation.

### BRIEF DESCRIPTION OF THE DRAWINGS

Embodiments of the invention will now be described by way of example with reference to the accompanying drawings in which:

FIG. 1 shows, schematically, an example of motion detection using paired devices;

FIG. 2 shows a simplified configuration of a system according to an embodiment of the present invention;

FIG. 3 shows an example of a time impulse response measurement using a system according to an embodiment of the present invention;

FIG. 4 shows a simplified configuration of a system according to a further embodiment of the present invention; and

FIG. 5 is a flow chart showing an overview of a method according an embodiment of the present invention.

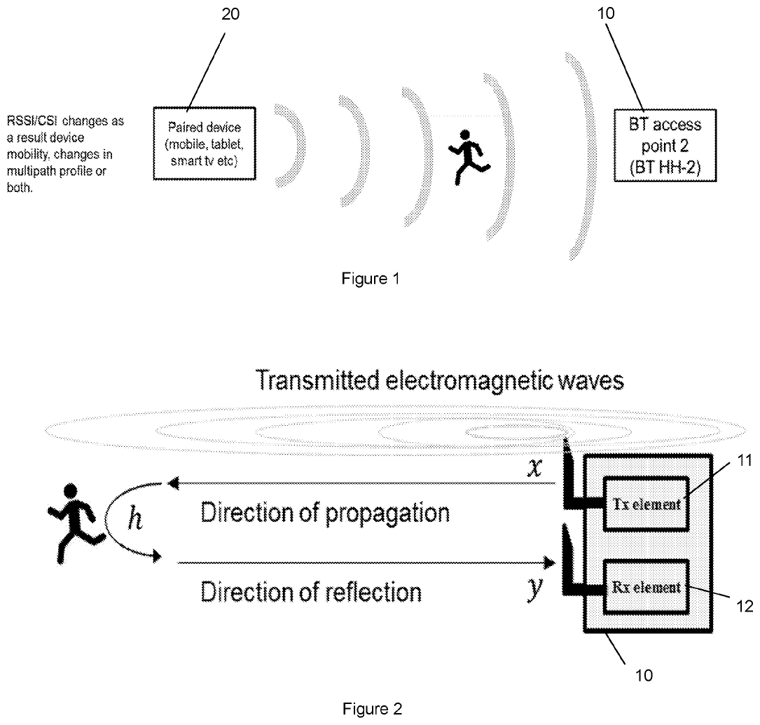

### DETAILED DESCRIPTION

At their broadest, aspects of the present invention provide for methods and devices for motion detection which use a wireless transceiver device.

A first aspect of the present invention provides a method of detecting motion of an object using a wireless transceiver device, the method including the steps of: transmitting wireless signals from a transmitter element in the transceiver device, the signals being reflected by the object; receiving the signals reflected by the object in a receiver element in the transceiver device; estimating at least one channel characteristic from the reflected signals; applying a time and/or frequency domain analysis to the estimated channel characteristic; detecting any variation in the estimated channel characteristic over time; and detecting motion of the object based on the detected variation.

The method of this aspect does not require paired devices and can detect motion with only a single transceiver device. The transceiver device may be, for example, a wireless access point such as a WiFi access point or a 5G hub.

The transmitter element and the receiver element are preferably arranged to allow for simultaneous transmission and reception. For example the wireless transceiver device may be a full duplex MIMO (which is to be taken as including sub-category techniques, e.g. MISO, SIMO and SISO) device.

The transmitted wireless signals may be carrier signals used by the wireless transceiver device for data transmission.

The method may further include selecting the number of transmitter elements and receiver elements in the transceiver device to be used for the transmitting and receiving of the signals. Increasing the number of transmitter elements can increase the power and coverage (e.g. range) of the detection, for example via maximal ratio transmission (MRT) Beamforming (i.e. MISO). Increasing the number of receiver elements can provide increased sensitivity for example by utilising maximal ratio combining (MRC) detection (i.e. SIMO).

Often the choice of the number of transmitter elements and receiver elements used for the motion detection will also have to take into account the demands on the device for data transmission.

The method may further include the step of determining a proportion of the transmission and reception capacity of the transmitter and receiver elements to be used for motion detection and a proportion to be used for data transmission. This can allow for a balance to be achieved between the motion detection and the normal data transmission requirements of the device.

The method may further include the step of dynamically adjusting said proportions based on one or more of: the demands for data transmission, the amount of moving objects detected, the number of devices in wireless communication with the wireless transceiver device. Thus the method can adapt to changes in the various demands on the signals and transmitter and receiver elements in the device.

The time and/or frequency domain analysis may include one or more of: time-gating, differential time and/or MUltiple Signal Classification (MUSIC) analyses. The time domain analysis may be a time impulse response.

The method of the present aspect may include any combination of some, all or none of the above described preferred and optional features.

The method of the above aspect is preferably implemented by a device according to the second aspect of this invention, as described below, but need not be.

Further aspects of the present invention include computer programs for running on computer systems which carry out the method of the above aspect, including some, all or none of the preferred and optional features of that aspect.

A second aspect of the present invention provides a wireless transceiver device having a transmitter element, a receiver element and a controller, wherein: the transmitter element is arranged to transmit wireless signals, which are reflected by an object; the receiver element is arranged to receive the reflected wireless signals; and the controller is arranged to: estimate at least one channel characteristic from the reflected signals; apply a time and/or frequency domain analysis to the estimated channel characteristic; and detect any variation in the estimated channel characteristic over time and thereby detect motion of the object based on the detected variation.

The device of this aspect does not require paired devices and can detect motion with only a single transceiver device. The transceiver device may be, for example, a wireless access point such as a WiFi access point or a 5G hub.

The transmitter element and the receiver element are preferably arranged to allow for simultaneous transmission and reception. For example the wireless transceiver device may be a full duplex MIMO device.

The transmitted wireless signals may be carrier signals used by the wireless transceiver device for data transmission.

The processor may be further arranged to select the number of transmitter elements and receiver elements in the transceiver device to be used for the transmitting and receiving of the signals. Increasing the number of transmitter elements can increase the power and coverage (e.g. range) of the detection. Increasing the number of receiver elements can provide increased sensitivity.

Often the choice of the number of transmitter elements and receiver elements used for the motion detection will also have to take into account the demands on the device for data transmission.

The processor may be further arranged to determine a proportion of the transmission and reception capacity of the transmitter and receiver elements to be used for motion detection and a proportion to be used for data transmission. This can allow for a balance to be achieved between the motion detection and the normal data transmission requirements of the device.

The processor may be further arranged to dynamically adjust said proportions based on one or more of: the demands for data transmission, the amount of moving objects detected, the number of devices in wireless communication with the wireless transceiver device. Thus the device can adapt to changes in the various demands on the signals and transmitter and receiver elements in the device.

The time and/or frequency domain analysis may include one or more of: time-gating, differential time and/or MUltiple Signal Classification (MUSIC), Maximum Likelihood Estimation and Minimum Mean Square Error Estimation (MMSE) analyses. The time domain analysis may be a time impulse response. MUSIC-based methods can provide direction of arrivals which can help narrowing the detection region for improved detraction accuracy.

The device of the present aspect may include any combination of some, all or none of the above described preferred and optional features.

MIMO (multiple input, multiple output) transceiver systems contain multiple antenna elements which, in classical systems, are used to transmit and receive data over separated time slots (time division duplex/TDD), frequencies (frequency division duplex/FDD), different antennas (spatial division duplex) and full duplex (transmit and receive simultaneously). Dedicated transmit (Tx) and receive (Rx) antennas are needed for continuous transmission and detection. Such an arrangement allows the capturing of instantaneous changes in the RF characteristics as depicted in FIG. 2.

Embodiments of the present invention use full duplex MIMO systems. The signal detection uses reference signals available for transmitting and receiving. Correlating two separate frequencies will always produce a null, hence frequency division duplexing is not an option. In time division duplexing, time guard bands separating downlinks and uplinks are highly likely to be longer than the propagation delay of reflected waves. Therefore detecting anything is extremely unreliable unless the moving target is extremely slow. Further, as guard times are likely to be very long compared to the propagation delay, any received reflections will be too faint to detect.

Current communication systems rely on multi-carrier modulation such discrete multi-tone (DMT) and orthogonal frequency division multiplexing (OFDM). Such systems have different types of carriers (also known as sub-carriers or tones). For example, data carriers form the largest portion and are responsible for data transfer whilst pilot carriers are training reference signals which are used to measure the channel/link losses via a channel estimation process.

These signals have unique phases, amplitudes and frequency locations known for both the transmitters and the receivers involved in the communication process.

There are many channel estimation techniques which may vary in complexity and accuracy but share fundamental characteristics. In the simplest system, such as that shown in FIG. 2, the reference signal (pilot carrier) x, is transmitted by an antenna (Tx) 11 to a receiver (Rx) 12. The received signal y at the receiver 12 is the result x propagating through a channel h which may involve bouncing over multiple objects and travelling a certain distance. Mathematically, y can be written as h*x, i.e. y=h*x. Given that the receiver 12 knows both x and y leaves only h being unknown.

Hence, the channel h can be simply estimated by rearranging this equation to as follows h=y/x. In MIMO systems where there are multiple channel coefficients involved, the channel can be decomposed and measured sequentially or in parallel by using array and matrix formats. Parallel channel estimation is faster but can suffer from numerical errors and requires more careful implementation. There will also be an element of background noise (n) received by the receiver 12 which adjusts the base equation to y=h*x+n. Techniques and treatments have been developed to separate the noise from the channel, and the use of such known techniques are assumed herein.

Once the channel estimation has been obtained, it is then used as the basis for a time and/or frequency domain analysis. This may involve a single or a series of techniques, such as time impulse response and MUSIC analyses. Time and space are linked by the equation v=d/t, where v is the velocity, d is the distance and t is time. In the case of radio waves (electromagnetic waves), v is the speed of light. If these waves are delayed or sped up by changes in the environment then time and/or frequency domain analysis should provide information as to the distance at which these changes occur because v can be assumed to be constant and time t is measurable, thus leaving d (i.e. the position of the target which is to be detected and located) as the unknown to be estimated/calculated from knowing v and t. In real-life scenarios, v can be scenario-specific (for example v can be slowed down when penetrating dielectrics other than vacuum), and can be obtain via training in the absence of motion and stored as a reference value to benchmark captured v values during monitoring. It is also possible that the reference v can be a distribution rather than a single value. Updating the reference v is important for accurate detection.

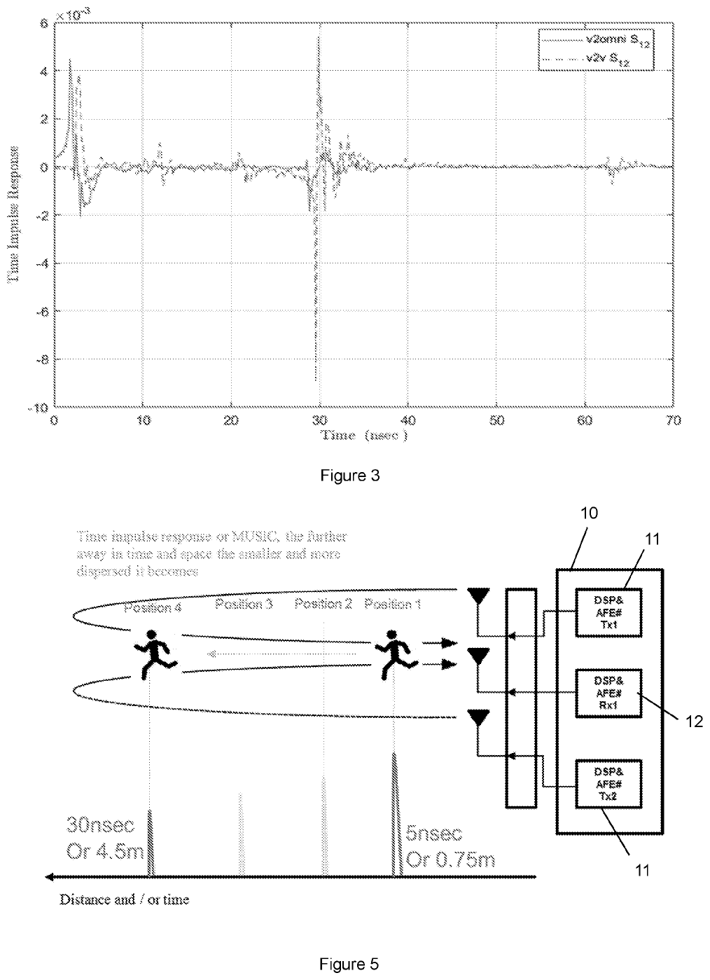

In embodiments of the present invention, variability in d or t is taken as a proof of motion and that should provide a positive detection. FIG. 3 shows the time impulse response using an experimental example based on the arrangement shown in FIG. 2 with two different setups. The channel estimations are converted to time impulse responses.

The first setup, labelled “v2v”, refers to the use of two Vivaldi antennas, one acting as a transmitter and one as a receiver. The second setup, labelled “v2omni” refers to the use of one Vivaldi and one omni-directional antenna. In both cases, reflections due to disturbances are detected within reasonable time window. For instance, the disturbances around 30 nsec are due to reflections at approximately 4.5 m. To compute this, d is v*t/2. The factor ½ is due to the round journey time of flight hence 2.998*10\hat{ }8 (m/s)*30/2*10\hat{ }−9 (s) is approximately 4.5 m. If this disturbance was to move lower in time then this would indicate that the target object is moving toward the MIMO detector.

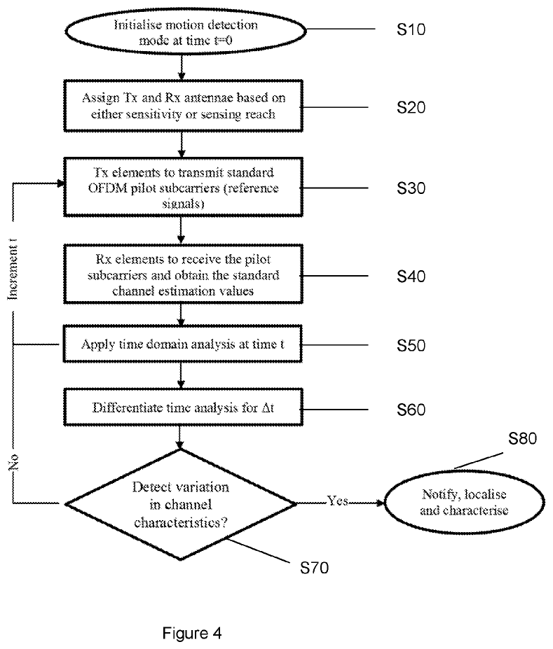

FIG. 4 is a flow chart setting out the steps in a method according to an embodiment of the present invention.

After initialising the motion detection functionality in step S10, transmit and receive antennae are assigned to the detection functionality in step S20. The number of antennae used for each may be selected based on desired sensitivity or reach as discussed further below.

The assigned transmitters transmit standard OFDM pilot subcarriers as reference signals (step S30) and the receivers receive reflected signals from the pilot subcarriers, allowing standard channel estimation to be performed (step S40). A time domain analysis (and/or a frequency domain analysis) for the current time t is applied (step S50).

The process is then repeated from step S30, whilst the time domain analysis (and/or frequency domain analysis) from step S50 is differentiated (step S60) and checked for any variation in the channel characteristics (step S70). If no variation is detected, then the process repeats. If a variation is detected then the detected motion is further localised and characterised and the system notified (step S80) thus allowing appropriate further processing or onward alerting to be carried out.

In embodiments which are more complex than that shown in FIG. 2, for example where the MIMO apparatus 10 has more than two elements (as shown, for example, in FIG. 5), the number of transmitter elements 11 determines the reach of detection where beamforming could be used, putting more energy to push further and detect hot spots of moving objects. Correspondingly, a greater number of receiver elements 12 maximise the likelihood of more accurate detection and minimise power consumption. Hence, the split of the MIMO array 10 between transmit 11 and receive 12 antenna elements can be optimised for larger systems to either maximise the reach or accuracy of the detection or to balance both.

FIG. 5 shows one possible arrangement of a more complex MIMO apparatus 10 having two transmitters 11 and one receiver 12 (there could more transmitters than receivers or the other way around as discussed earlier).

The arrangement in FIG. 5 works by monitoring variations in the time impulse response (equivalent to the channel state information in the frequency domain). If the time impulse response does not exhibit any variation across the time domain then it means no motion is present. Conversely, when motion is present, the ripples in the time domain will become variable as shown in the lower part of FIG. 5 which can be associated with positions 1 and 4 as the impulse response moves in time and amplitude.

The configuration of the transmit and receive switching can have variable configurations. For example, High resolution motion detection may require a full and permanent dedication of antenna elements and drivers for constant monitoring. However, this has the disadvantage of sacrificing hardware to perform monitoring rather than the primary function of data transmission. In contrast, medium and low motion detection may require less frequent switching which could therefore be optimised to balance impact on transmission performance.

Both implementations can be aided by learning algorithms which allow transition from low level monitoring (when motion is low or non-existent) to intense monitoring (when motion events are dominant). The apparatus can also adapt and balance regular network traffic against monitoring demands for resident MAC IDs based on their digital activities.

Channel state information measurement described above is merely one way of implementing embodiments of the invention and other state of the art approaches could also be used.

Time gating or differentiating variable ripples in the time impulse response can be done crudely or via more optimised methods. For instance, time of flight (t) associated with range (d) that is greater than the span of the area of interest becomes irrelevant and rather harmful to computations and performance, hence time gating can allow monitoring to narrow the detection range to filter out irrelevant information and improve the quality of detection.

Furthermore, correlation-based methods can use adaptive thresholding to tune sensitivity and the MIMO array split ratio. For instance, detection can be initialised with MISO to maximise range of detection, if no motion is detected then a transmit element is transferred to receive element iteratively one at a time to improve sensitivity until a detection is achieved. This applies to localisation and motion characterisation. Threshold values can be established after gathering sufficient amount of observation data to improve the speed of system adaptation.

The systems and methods of the above embodiments may be implemented in a computer system (in particular in computer hardware or in computer software) in addition to the structural components and user interactions described.

The term “computer system” includes the hardware, software and data storage devices for embodying a system or carrying out a method according to the above described embodiments. For example, a computer system may comprise a central processing unit (CPU), input means, output means and data storage. Preferably the computer system has a monitor to provide a visual output display. The data storage may comprise RAM, disk drives or other computer readable media. The computer system may include a plurality of computing devices connected by a network and able to communicate with each other over that network.

The methods of the above embodiments may be provided as computer programs or as computer program products or computer readable media carrying a computer program which is arranged, when run on a computer, to perform the method(s) described above.

The term “computer readable media” includes, without limitation, any non-transitory medium or media which can be read and accessed directly by a computer or computer system. The media can include, but are not limited to, magnetic storage media such as floppy discs, hard disc storage media and magnetic tape; optical storage media such as optical discs or CD-ROMs; electrical storage media such as memory, including RAM, ROM and flash memory; and hybrids and combinations of the above such as magnetic/optical storage media.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

In particular, although the methods of the above embodiments have been described as being implemented on the systems of the embodiments described, the methods and systems of the present invention need not be implemented in conjunction with each other, but can be implemented on alternative systems or using alternative methods respectively.

All references referred to above are hereby incorporated by reference.

1. A method of detecting motion of an object using a wireless transceiver device, the method including the steps of:
transmitting wireless signals from a transmitter element in the transceiver device, the signals being reflected by the object;
receiving the signals reflected by the object in a receiver element in the transceiver device;
estimating at least one channel characteristic from the reflected signals;
applying time and/or frequency domain analysis to the estimated channel characteristic;
detecting any variation in the estimated channel characteristic over time; and
detecting motion of the object based on the detected variation.

2. A method according to claim 1 further including selecting the number of transmitter elements and receiver elements in the transceiver device to be used for the transmitting and receiving of the signals.

3. A method according to claim 1 wherein the wireless transceiver device is a full duplex MIMO device.

4. A method according to claim 1 wherein the time and/or frequency domain analysis include one or more of: a time impulse response and/or Multi-Signal-Classification-like estimators.

5. A method according to claim 1 wherein the transmitted wireless signals are the carrier signals used by the wireless transceiver device for data transmission.

6. A method according to claim 1, further including the step of determining a proportion of the transmission and reception capacity of the transmitter and receiver elements to be used for motion detection and a proportion to be used for data transmission.

7. A method according to claim 6 further including the step of dynamically adjusting said proportions based on one or more of: the demands for data transmission, the amount of moving objects detected, the number of devices in wireless communication with the wireless transceiver device.

8. A wireless transceiver device having a transmitter element, a receiver element and a controller, wherein:
the transmitter element is arranged to transmit wireless signals, which are reflected by an object;
the receiver element is arranged to receive the reflected wireless signals; and
the controller is arranged to:
estimate at least one channel characteristic from the reflected signals;
apply a time and/or frequency domain analysis to the estimated channel characteristic; and
detect any variation in the estimated channel characteristic over time and thereby detect motion of the object based on the detected variation.

9. A device according to claim 8 wherein the processor is further arranged to select the number of transmitter elements and receiver elements in the transceiver device to be used for the transmitting and receiving of the signals.

10. A device according to claim 8 wherein the device is a full duplex MIMO device.

11. A device according to claim 8 wherein the time and/or frequency domain analysis includes one or more of: a time impulse response and/or Multi-Signal-Classification-like estimators.

12. A device according to claim 8, wherein the transmitted wireless signals are the carrier signals used by the wireless transceiver device for data transmission.

13. A device according to claim 8, wherein the processor is further arranged to determine a proportion of the transmission and reception capacity of the transmitter and receiver elements to be used for motion detection and a proportion to be used for data transmission.

14. A device according to claim 13 wherein the processor is arranged to dynamically adjust said proportions based on one or more of: the demands for data transmission, the amount of moving objects detected, the number of devices in wireless communication with the wireless transceiver device.

15. A wireless transceiver device having a transmitter element, a receiver element and a controller, wherein:
the transmitter element is arranged to transmit wireless signals, which are reflected by an object;
the receiver element is arranged to receive the reflected wireless signals; and
the controller is arranged to:
estimate at least one channel characteristic from the reflected signals;
apply a time and/or frequency domain analysis to the estimated channel characteristic, the time and/or frequency domain analysis including one or more of: a time impulse response and/or Multi-Signal-Classification-like estimators;
detect any variation in the estimated channel characteristic over time and thereby detect motion of the object based on the detected variation;
determine a proportion of the transmission and reception capacity of the transmitter and receiver elements to be used for motion detection and a proportion to be used for data transmission and to dynamically adjust said proportions based on one or more of: the demands for data transmission, the amount of moving objects detected, the number of devices in wireless communication with the wireless transceiver device; and
select the number of transmitter elements and receiver elements in the transceiver device to be used for the transmitting and receiving of the signals
